(19) United States
(12) Patent Application Publication
(10) Pub. No.: US 2022/0398288 A1
(43) Pub. Date: Dec. 15, 2022

(54) GENERATING CONTEXTUAL DATA AND VISUALIZATION RECOMMENDATIONS

(71) Applicant: KYNDRYL, INC., NEW YORK, NY (US)

(72) Inventors: Dinesh G. Venkatraman, Bangalore (IN); Hariharan N. Venkitachalam, Bengaluru (IN); Alankar Srivastava, Bangalore (IN); D Krishna Vinci, West Godavari District (IN)

(21) Appl. No.: 17/304,051

(22) Filed: Jun. 14, 2021

(51) Int. Cl. G06F 16/9538; G16Y 10/75; G16Y 20/20

(52) U.S. Cl. CPC G06F 16/9538; G16Y 10/75; G16Y 20/20

(57) ABSTRACT

In an approach to improve recommendation generating through IoT devices, embodiments abstract specific messaging formats from various IoT devices, map, the abstracted messaging formats to a canonical model associated to device types using based on collected IoT device data, and determine a context of data received from the plurality of IoT devices based on the type of IoT device and historical trend analysis of canonical data points from similar device types. Further, embodiments derive an association between data points among the plurality of IoT devices in a solution, determine one or more contexts of the established data point associations in the solution, and recommend one or more charts, events, and associated data based on a derived context and a visualization map. Additionally, embodiments output, by a user interface, the recommended chart events and associated data.

### BACKGROUND OF THE INVENTION

The present invention relates generally to the field of internet of things (IoT), and more particularly to generating recommendations for data feeds, event triggers and visualizations.

There are three main source categories for contextual data: (i) third-party businesses and organizations (e.g., weather, news, events, traffic, and economic/market changes), (ii) customers (e.g., social media activity, past buying behavior, customer preferences, location, and milestones), and things (e.g., delivery trackers, asset and inventory management sensors, kiosk interactions, GPS tools, context-aware promotion tools, and contextual data in action). With the growing popularity of smart and/or wearable devices, many users are benefiting from context data-driven customer experience in their everyday lives. Current, artificial intelligence (AI) models learn to provide better suggestions based on previous behavior, while smartphones provide inclement weather warnings based on your location.

Internet of things (IoT) describes a network of physical activity objects, things or objects, that are bedded with sensors, artificial colors, software, and other metallic technologies for the purpose of connecting and exchanging data with other devices and systems over the internet. Traditional fields of embedded systems, wireless sensor networks, control systems, automation (including home and building automation), and other systems known in the art contribute to enabling the IoT. In the consumer market, IoT technology is most synonymous with products pertaining to the concept of a smart home, including devices and appliances (such as lighting fixtures, thermostats, home security systems and cameras, and other home appliances) that support one or more common ecosystems, and can be controlled via devices associated with that ecosystem, such as smartphones and smart speakers. However, IoT technology can be applied to supply chains to track goods.

### SUMMARY

Embodiments of the present invention disclose a computer-implemented method, a computer program product, and a system for providing recommendations based on extracted context from a plurality of IoT devices, embodiments comprise: abstracting specific messaging formats from various IoT devices; mapping, by a canonical data mapper, the abstracted messaging formats to a canonical model associated to device types using based on collected IoT device data; determining a context of data received from the plurality of IoT devices based on the type of IoT device and historical trend analysis of canonical data points from similar device types; deriving an association between data points among the plurality of IoT devices in a solution; determining one or more contexts of the established data point associations in the solution; recommending one or more charts, events, and associated data based on a derived context and a visualization map; and outputting, by a user interface, the recommended chart events and associated data.

### BRIEF DESCRIPTION OF THE DRAWINGS

FIG. 1 is a functional block diagram illustrating a distributed data processing environment, in accordance with an embodiment of the present invention;

FIG. 2 illustrates dataflow of a modification component, on a server computer within the distributed data processing environment of FIG. 1, for generating recommendations for data feeds, event triggers and visualizations, in accordance with an embodiment of the present invention;

FIG. 3 illustrates operational steps of the modification component, on a server computer within the distributed data processing environment of FIG. 1, for generating recommendations for data feeds, event triggers and visualizations, in accordance with an embodiment of the present invention; and

FIG. 4 depicts a block diagram of components of the server computer executing the modification component within the distributed data processing environment of FIG. 1, in accordance with an embodiment of the present invention.

### DETAILED DESCRIPTION

With the exponential growth of internet of things (IoT) devices in the current digital era embodiments recognize that establishing the association between data points and gaining the overall data context based variety of messages from a multitude of devices is difficult and important for gaining analytical insights and driving key business decisions in an enterprise. Moreover, embodiments recognize that it is challenging to establish the association between data points and gaining the overall data context based variety of messages from multitude of devices, because of the faster rate of proliferation of diverse set of such IoT devices and data formats coupled with the lack of strong standardization in the IoT field.

Embodiments of the present invention recognize that the number and variant of IoT devices, in addition to the data provided by the IoT devices, are continuously growing exponentially. However, embodiments of the present invention recognize that the existing solutions designed to consume and process the large amount of data being generated and/or collected by the growing number of IoT devices continue to be custom and very specific to particular devices and a particular device's data format.

Additionally, embodiments of the present invention recognize that there are no existing methods, in the art, that are designed to apply artificial intelligence (AI) approaches to leverage the historical data and gain overall data context dynamically from the IoT devices in an IoT solution and provide recommendations. Currently, embodiments of the present invention recognize that there are existing IoT offerings that collect device metrices from a multitude of IoT devices with varied data formats. Additionally, embodiments of the present invention recognize that some of the existing IoT offerings aim to provide analytical insights to effectively manage the lifecycle of IoT devices in an IoT solution deployment.

Embodiments of the present invention improve the art and provide specific solutions to the problems stated above by using AI to establish data associations and dynamically extract data context from diverse IoT device data. Additionally, embodiments of the present invention generate various recommendations concerning the building of visual representations and data feeds based on the established data associations and dynamically extracted data context, which may drive business decisions in an enterprise. Further, embodiments of the present invention improve the current art by (i) utilizing an AI assisted context recommendation engine that extracts data context from a plurality of IoT devices and (ii) applying context mappings to provide recommendations on data feeds, event triggers and visualizations. Additionally, embodiments of the present invention improve the art by (i) applying abstraction of various IoT device specific message formats and mapping, by a canonical data mapper, the abstraction of various IoT device specific message formats to a canonical model associated to device types such as sensors, location, computes, and/or mobiles; (ii) determining the context of data received from a plurality of IoT devices based on the type of the device and the historical trend analysis of canonical data points from similar devices; and (iii) establishing an association between data points among IoT devices in the solution and determining the contexts of the established data point associations in the solution. In various embodiments, the specific message formats are predetermined.

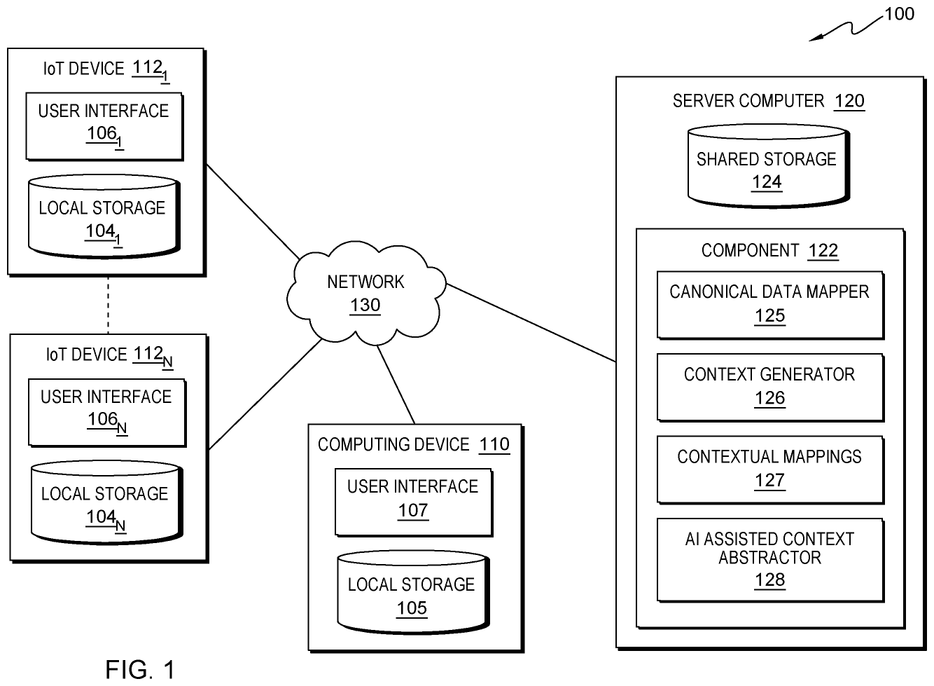

Implementation of embodiments of the invention may take a variety of forms, and exemplary implementation details are discussed subsequently with reference to the Figures (i.e., FIG. 1-FIG. 4).

FIG. 1 is a functional block diagram illustrating a distributed data processing environment, generally designated 100, in accordance with one embodiment of the present invention. The term “distributed” as used in this specification describes a computer system that includes multiple, physically distinct devices that operate together as a single computer system. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims. Distributed data processing environment 100 includes computing device 110, internet of things (IoT) device 112₁-112_{N}, hereinafter IoT device(s) 112, and server computer 120 interconnected over network 130. As used herein, N represents a positive integer, and accordingly the number of scenarios implemented in a given embodiment of the present invention is not limited to those depicted in FIG. 1.

Network 130 may be, for example, a storage area network (SAN), a telecommunications network, a local area network (LAN), a wide area network (WAN), such as the Internet, a wireless technology for exchanging data over short distances (using short-wavelength ultra-high frequency (UHF) radio waves in the industrial, scientific and medical (ISM) band from 2.4 to 2.485 GHz from fixed and mobile devices, and building personal area networks (PANs) or a combination of the three), and may include wired, wireless, or fiber optic connections. Network 130 may include one or more wired and/or wireless networks that may receive and transmit data, voice, and/or video signals, including multimedia signals that include voice, data, text and/or video data. In general, network 130 may be any combination of connections and protocols that will support communications between computing device 110, IoT device(s) 112 and server computer 120, and any other computing devices and/or storage devices (not shown in FIG. 1) within distributed data processing environment 100.

In some embodiments of the present invention, computing device 110 may be, but is not limited to, a standalone device, a client, a server, a laptop computer, a tablet computer, a netbook computer, a personal computer (PC), a smart phone, a desktop computer, a cloud based service (e.g., a cognitive cloud based service), AR glasses, a virtual reality headset, any HUD known in the art, and/or any programmable electronic computing device capable of communicating with various components and devices within distributed data processing environment 100, via network 130 or any combination therein. In general, computing device 110 may be representative of any programmable computing device or a combination of programmable computing devices capable of executing machine-readable program instructions and communicating with users of other computing devices via network 130 and/or capable of executing machine-readable program instructions and communicating with server computer 120. In some embodiments computing device 110 may represent a plurality of computing devices.

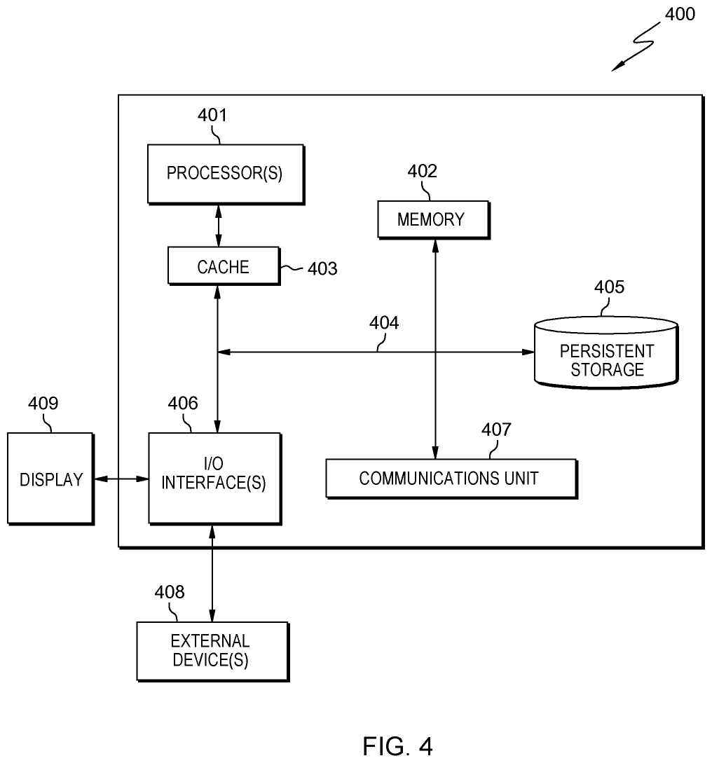

In some embodiments of the present invention, computing device 110 may represent any programmable electronic computing device or combination of programmable electronic computing devices capable of executing machine readable program instructions, manipulating executable machine-readable instructions, and communicating with server computer 120 and other computing devices (not shown) within distributed data processing environment 100 via a network, such as network 130. computing device 110 may include an instance of user interface (interface) 107, and local storage 105. In various embodiments, not depicted in FIG. 1, computing device 110 may have a plurality of interfaces 107. In other embodiments, not depicted in FIG. 1, distributed data processing environment 100 may comprise a plurality of computing devices, plurality of server computers, and/or one a plurality of networks. computing device 110 may include internal and external hardware components, as depicted, and described in further detail with respect to FIG. 4.

User interface (interface) 107 provides an interface to component 122. Computing device 110, via user interface 107, may enable a user and/or a client to interact with component 122 and/or server computer 120 in various ways, such as sending program instructions, receiving program instructions, sending and/or receiving messages, updating data, sending data, inputting data, editing data, collecting data, and/or receiving data. In one embodiment, interface 107 may be a graphical user interface (GUI) or a web user interface (WUI) and may display at least text, documents, web browser windows, user options, application interfaces, and instructions for operation. Interface 107 may include data (such as graphic, text, and sound) presented to a user and control sequences the user employs to control operations. In another embodiment, interface 107 may be a mobile application software providing an interface between a user of computing device 110 and server computer 120. Mobile application software, or an “app,” may be designed to run on smart phones, tablet computers and other computing devices. In an embodiment, interface 107 may enable the user of computing device 110 to at least send data, input data, edit data (annotations), collect data and/or receive data.

IoT device(s) 112 may be any device, known in the art, that is able to connect to network 130 (e.g., the internet) and has sensors capable of transmitting data over network 130. IoT device(s) 112 may be, but are not limited to, a smart television, a smart watch, a smart radio or stereo system, smart lightbulb, smart fitness device, smart toaster, smart thermostat, smart refrigerator, and/or any other smart device as they are known and understood in the art. IoT device(s) 112 may include wireless sensors, software, actuators, and computer devices. IoT device(s) 112 may be attached to a particular object that operates through the internet, enabling the transfer of data among objects or users automatically without user intervention. For example, IoT systems in a vehicle identify the traffic ahead and automatically output messages to the driver, via a smart phone alerting the driver of the identified traffic ahead. In the depicted embodiment, IoT device(s) 112 comprise interface (interface) 106₁-106_{N}, hereinafter interface(s) 106 and local storage 104₁-104_{N}, hereinafter local storage(s) 104. As used herein, N represents a positive integer, and accordingly the number of scenarios implemented in a given embodiment of the present invention is not limited to those depicted in FIG. 1. In some embodiments of the present invention, IoT device(s) 112 comprises a speaker component, a microphone component, a camera component, and/or any other component or sensor known in the art. In other embodiments, not depicted in FIG. 1, IoT device(s) 112 may not comprise interface(s) 106 and/or local storage(s) 104.

Interface(s) 106 may provide an interface to component 122. IoT device(s) 112, via user interface(s) 106, may enable a user and/or a client to interact with component 122 and/or server computer 120 in various ways, such as sending program instructions, receiving program instructions, sending and/or receiving messages, updating data, sending data, inputting data, editing data, collecting data, and/or receiving data. In one embodiment, interface(s) 106 may be a graphical user interface (GUI) or a web user interface (WUI) and may display at least text, documents, web browser windows, user options, application interfaces, and instructions for operation. interface(s) 106 may include data (such as graphic, text, and sound) presented to a user and control sequences the user employs to control operations. In another embodiment, interface(s) 106 may be a mobile application software providing an interface between a user of IoT device(s) 112 and computing device 110 and/or server computer 120. Mobile application software, or an “app,” may be designed to run on smart phones, tablet computers and other computing devices. In an embodiment, interface(s) 106 may enable the user of IoT device(s) 112 to at least send data, input data, edit data (annotations), collect data and/or receive data.

Server computer 120 may be a standalone computing device, a management server, a web server, a mobile computing device, one or more client servers, or any other electronic device or computing system capable of receiving, sending, and processing data. In other embodiments, server computer 120 may represent a server computing system utilizing multiple computers such as, but not limited to, a server system, such as in a cloud computing environment. In another embodiment, server computer 120 may represent a computing system utilizing clustered computers and components (e.g., database server computers, application server computers, etc.) that act as a single pool of seamless resources when accessed within distributed data processing environment 100. Server computer 120 may include internal and external hardware components, as depicted, and described in further detail with respect to FIG. 4. In some embodiments server computer 120 may represent a plurality of server computers.

Each of shared storage 124, local storage 105, and local storage(s) 104 may be a data/knowledge repository and/or a database that may be written and/or read by one or a combination of component 122, server computer 120, computing device 110, and IoT device(s) 112. In the depicted embodiment, shared storage 124 resides on server computer 120, local storage 105 resides on computing device 110, and local storage(s) 104 resides on IoT device(s) 112. In another embodiment, shared storage 124, local storage 105, and/or local storage(s) 104 may reside elsewhere within distributed data processing environment 100, provided that each may access and is accessible by IoT device(s) 112, computing device 112, and/or server computer 120. Shared storage 124, local storage 105, and/or local storage(s) 104 may each be implemented with any type of storage device capable of storing data and configuration files that may be accessed and utilized by server computer 120, such as, but not limited to, a database server, a hard disk drive, or a flash memory.

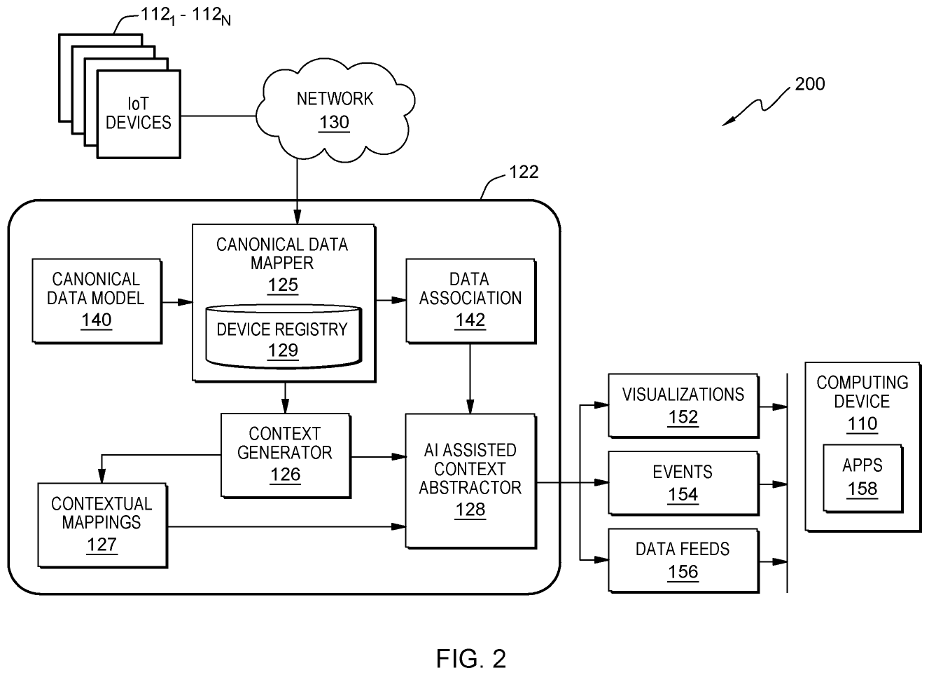

In the depicted embodiment, component 122 is executed on server computer 120. In other embodiments, component 122 may be executed on IoT device(s) 112 or computing device 110. In various embodiments of the present invention, not depicted in FIG. 1, component 122 may execute on a plurality of server computers 120 and/or on a plurality of computing devices 110. In some embodiments, component 122 may be located and/or executed anywhere within distributed data processing environment 100 as long as component 122 is connected to and/or communicates with, IoT device(s) 112, computing device 110, and/or server computer 120, via network 130. In the depicted embodiment, component 122 comprises canonical data mapper 125, context generator 126, contextual mappings 127 and artificial intelligence (AI) assisted context abstractor 128, further described in FIG. 2. Further, in the depicted embodiment, canonical data mapper 125, context generator 126, contextual mappings 127 and AI assisted context abstractor 128 each execute on component 122 within server computer 120. However, in other embodiments, not depicted in FIG. 1, canonical data mapper 125, context generator 126, contextual mappings 127 and AI assisted context abstractor 128 may each execute anywhere within distributed data processing environment 100 of FIG. 1 as long as canonical data mapper 125, context generator 126, contextual mappings 127 and AI assisted context abstractor 128 communicate with sever computer 120, computing device 110, and/or IoT device(s) 112.

Component 122 may extract data context from IoT device(s) 112 and apply context mappings, via contextual mappings 127, and AI assisted context recommendation engine (e.g., AI assisted context abstractor 128), to provide recommendations on data feeds, event triggers, and visualizations. In various embodiments of the present invention, component 122, context generator 126, dynamically generates data context and provides recommendations in the form of events, data feeds, visualizations based on the received data from IoT device(s) 112. In various embodiments of the present invention, component 122 applies abstraction of the various IoT device specific message formats and maps, via canonical data mapper 125, wherein the applied abstractions to a canonical model are associated to device types such as sensors, location, computes (e.g., any computing device such as servers, desktops, laptops, and/or tablets). Abstraction is used herein as it is known and understood in the art. More specifically, abstraction is the process of removing physical, spatial, or temporal details or attributes in the study of objects or systems to focus attention on details of greater importance. Further, abstraction is similar in nature to the process of generalization. Additionally, the creation of abstract concept-objects by mirroring common features or attributes of various non-abstract objects or systems of study may result in the process of abstraction.

Component 122 may determine the context of data received from IoT device(s) 112 based on the type of the device IoT device(s) 112 is labeled or identified as and the historical trend analysis of canonical data points from devices similar to the device IoT device(s) are labeled or identified as. In various embodiments of the present invention, component 122 establishes association between data points among IoT devices in the solution and determining the contexts.

FIG. 2 illustrates dataflow of component 122, generally designated 200, in communication with server computer 120 and/or IoT device(s) 112, within distributed data processing environment 100 of FIG. 1, for dynamically generating contextual data and visualization recommendations based on identified data context from a plurality of IoT devices, in accordance with an embodiment of the present invention. FIG. 2 provides an illustration of one implementation and does not imply any limitations with regard to the environments in which different embodiments may be implemented. Many modifications to the depicted environment may be made by those skilled in the art without departing from the scope of the invention as recited by the claims.

In the depicted embodiment, component 122 retrieves contextual data from IoT device(s) 112, via network 130. In various embodiments of the present invention, component 122 may receive or retrieve contextual data, via canonical data mapper 125, from IoT device(s) 112, wherein contextual data is generated through user interactions with IoT device(s) 112 and/or events, state changes, properties, actions, and/or thresholds executed on or by IoT device(s) 112. Canonical data mapper 125 may generate models (e.g., canonical data model) using machine learning (ML). Canonical data mapper 125 is a machine learning (ML) based component that parses structured/unstructured data from IoT devices and maps them to one or more canonical data models. Canonical data model 140 may execute an elastic search on collected datapoints. Canonical data model 140 is a normalized data model that has a representation of datapoints common across multitude of IoT device(s) 112.

Data association engine (data association) 142 is analytical model that profiles the data feed from devices (e.g., IoT device(s) 112) and creates association between datapoints based on historical data profile. Contextual mappings engine (contextual mappings) 127 manages the mapping of data context and most appropriate visualization representations. Context generator engine (context generator) 126 analytical model that recommends context of a data from IoT device(s) 112 based on the trend of historical data from the device. AI assisted context abstractor 128 consumes data context and visualization mappings to generate and output recommendations such as data visualizations 152, events 154, data feeds 156, and actions based on the data in the current form and the context.

In the depicted embodiment, canonical data mapper 125 retrieves and or receives data from IoT device(s) 112 (i.e., IoT device data) over network 130. In various embodiments of the present invention, the data retrieved and or received by canonical data mapper 125 comprises: events, state changes, device properties, user preferences, actions, and thresholds. In some embodiments, the retrieved and/or received data is predetermined. Canonical data mapper 125 parses structured and/or unstructured data from IoT device(s) and maps the parsed data through canonical data model 140. In various embodiments of the present invention, canonical data mapper 125 registers IoT device details (i.e., IoT data) to device registry 129, wherein device registry 129 is a database similar to local storage(s) 104, local storage 105, and/or shared storage 124. In the depicted embodiment, data association 142 receives and/or retrieves IoT data from canonical data mapper 125. Data association 142 profiles the IoT data feed from IoT device(s) 112 and creates an association between datapoints in the IoT device data and datapoints in one or more historical IoT data profiles. In the depicted embodiment, context generator 126 receives and/or retrieves IoT data from canonical data mapper 125. In various embodiments of the present invention, context generator 126 identifies and recommends data context associated with the received IoT data based on one or more identified trends of historical IoT data. In various embodiments of the present invention, component 122, via canonical data mapper 125 stores IoT data in device registry 129, wherein the stored IoT data is retrievable. In other embodiments, IoT data is stored on shared storage 124 and/or local storage(s) 104.

In the depicted embodiment, contextual mapping 127 receives and/or retrieves the recommended data context from context generator 126. Contextual mappings 127 may manage the data context mapping and visualization representations of the recommended data context. In the depicted embodiment, AI assisted context abstractor 128 receives and/or retrieves context data and visualization mappings from context generator 126, contextual mappings 127, and/or data association 142. In various embodiments of the present invention, AI assisted context abstractor 128 consumes the context data and visualization mappings from context generator 126, contextual mappings 127, and/or data association 142 and generates recommendations, wherein the recommendations comprise, but are not limited to: visualizations 152, events 154 and data feeds 156. In various embodiments of the present invention, AI assisted context abstractor 128 outputs the generated recommendations (e.g., visualizations 152, events 154 and data feeds 156) to one or more users via one or more mobile applications (apps) 158 on computing device 110. Apps 158 are mobile applications as they are known and understood in the art. In various embodiments of the present invention, interface 107 enables visual display of visualizations 152, events 154 and data feeds 156 to one or more users.

In an example, an IoT solution was executed to absorb a plurality of IoT device data and ensure food packages remained fresh and intact by monitoring each food package (e.g., carton) throughout the supply chain. This example produces a segmented monitoring solutions. Depending on each segment the same data needs to be visualized as per different solutions and different users. In the proposed underlying IoT infrastructure, in this particular example used Radio-frequency identification (RFID) tags/readers and temperature sensors to monitor food packages throughout the supply chain.

In one particular example, when one or more new IoT device(s) 112 is deployed, canonical data mapper 125 registers and maintains the IoT device data in device registry 129. Once one or more IoT device(s) 112 are registered canonical data mapper 125 may parse messages sent by the one or more IoT device(s) 112. In this example canonical data mapper 125 maintains a list of common attributes shared by IoT devices which are annotated with texts that are associated to specific attribute names. This mapping can be modeled using a machine learning (ML) classifier. Canonical data mapper 125 applies the ML Classifier on the incoming messages to transform them into one or more canonical data models and groups the attributes as a comprehensive IoT solution level dataset based on the canonical data model.

In this example, canonical data mapper 125 then passes this comprehensive canonical data message to the context generator 126 which parses each of the incoming attributes to analyze the trend of that attribute over historical data and associate one or more attributes to other attributes that the attribute impacts. Context generator 126 then generates one or more contextual outcomes (e.g., “attribute1” continuously changes based on “attribute2”, whenever “attribute1” crosses “threshold value”, attribute2″ changes its “state”). In this example, context generator 126 then passes the one or more generated contextual outcomes to AI enabled recommendation engine (AI assisted context abstractor) that generates recommendations based on predetermined rule mapping which is managed by ML based models. For example, two related entities impacting values, can be represented as line chart entity-1 changing state on entity-2 reaching threshold can trigger a threshold breach notification. The data context and recommendations are subscribed by the consumers who can consume the data through events, data feeds via application programing interface (API) or as a command center dashboard which on receiving the recommendations can take appropriate action like triggering an email or using the data feed to determine the health of the device or using the visualization recommendations to render one or more user interface (UI) widgets.

Component 122 generates contextual data originating from IoT devices based on characteristics such as, but not limited to, device type, location of origin, time of origin, relative data variances, and/or relationship of data over a period of time/location. Component 122 may apply ML models to provide various types of recommendations such as, but not limited to, event triggers, data feeds, and/or visualizations.

For example, if the data source is a temperature sensor and the incoming data feed shows continuous variance of data over a time period, then the ML model identifies that the data context from the data source is showing a property variance over a period of time from a sensor device based on initial configurations and historical data. In this example, component 122, via the ML model, then determines an optimal threshold value of the property, which is temperature in this case, based on the historical data for such devices and sends recommendations to a user (e.g., client). In some embodiments, if the client subscribes to events then the generated and issued recommendations may be an event notifying the client of a possible threshold breach. In other embodiments, if the client subscribed to visual recommendations then the generated and issued recommendations may be a visualization in the form of a line chart or a data feed to programs consume data feeds via API.

In another example, if the data source is a computing device such as a desktop or laptop and the incoming data feed contains various resource usage metrics such as, but not limited to CPU usage, memory usage, and disk usage, then component 122, via the ML model, identifies the context that the incoming data is about resource utilization over time from a computing device. In this example, component 122, based on the interpreted data feed from the computing device, sends recommendations such as an event notifying the bad health of a device when the resource usage peaks or breaches a predetermined threshold and a line chart comparing the relative variances of metrics such as CPU vs Memory usage.

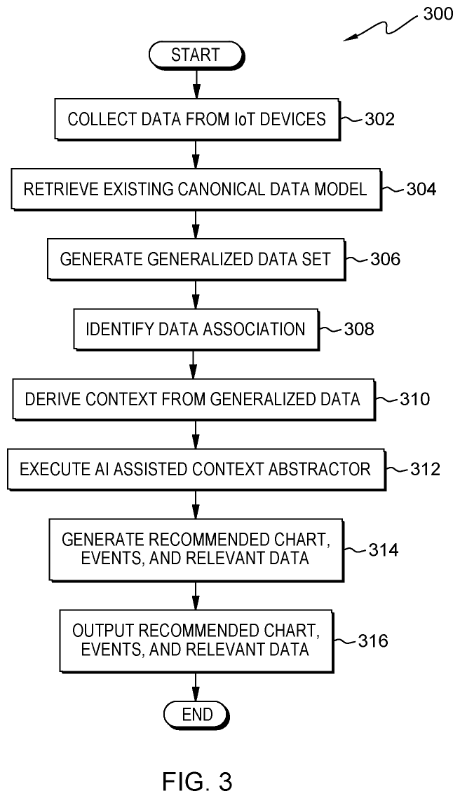

FIG. 3 illustrates operational steps of component 122, generally designated 300, in communication with server computer 120 and/or IoT device(s) 112, within distributed data processing environment 100 of FIG. 1, for generating recommendations for data feeds, event triggers and visualizations, in accordance with an embodiment of the present invention. FIG. 3 provides an illustration of one implementation and does not imply any limitations with regard to the environments in which different embodiments may be implemented. Many modifications to the depicted environment may be made by those skilled in the art without departing from the scope of the invention as recited by the claims.

In step 302, component 122 collects data from IoT device(s) 112. In various embodiments of the present invention, component 122, via canonical data mapper 125, retrieves and/or receives IoT device data from IoT device(s) 112.

In step 304, component 122 retrieves an existing canonical data model. In various embodiments of the present invention, component 122, via canonical data mapper 125, retrieves one or more existing canonical data models from canonical data model 140 or previously stored canonical data models in shared storage 124 and/or local storage(s) 104. In various embodiments of the present invention, canonical data model 140 may generate and output new canonical data models based on the retrieved and/or received IoT data.

In step 306, component 122 generates a generalized data set. In various embodiments of the present invention, component 122, via canonical data mapper 125, matches IoT data with the one or more retrieved or generated canonical models to generate a generalized data set. In various embodiments, component 122 generates, by canonical data mapper 125, a generalized data set based on the collected data (e.g., user data and IoT device data) and existing canonical data model by matching IoT data with one or more retrieved canonical models

In step 308, component 122 identified data association in the generated generalized data. In various embodiments of the present invention, component 122, via data association 142, identifies data association between datapoints in the received and/or retrieved IoT device data and datapoints in one or more historical IoT data profiles. In various embodiments of the present invention, component 122, via data association 142, profiles the IoT data feed from IoT device(s) 112 and creates an association between datapoints in the IoT device data and datapoints in one or more historical IoT data profiles.

In step 310, component 122 derives context from generalized data and/or identified data association. In various embodiments of the present invention, component 122, via context generator 126, derives context from the generalized data in steps 306 and 308. In various embodiments of the present invention, component 122, via contextual mapping 127 maps the generated context and generated visual representations.

In step 312, component 122 executes AI assisted context abstractor 128. In various embodiments of the present invention, component 122 executes AI assisted context abstractor 128 to consume data context and visualization mappings to generate recommendations such as data visualizations, data feeds, and actions based on the data in the current form and the context.

In step 314, component 122 generates recommended chart, events, and data associated with the data context and visualization mapping. In various embodiments of the present invention, AI assisted context abstractor 128 receives and/or retrieves context data and visualization mappings from context generator 126, contextual mappings 127, and/or data association 142. In various embodiments of the present invention, AI assisted context abstractor 128 consumes the context data and visualization mappings from context generator 126, contextual mappings 127, and/or data association 142 and generates recommendations, wherein the recommendations comprise, but are not limited to: visualizations 152, events 154 and data feeds 156.

In step 316, component 122 outputs recommended chart, events, and data associated with the generated recommendations. In various embodiments of the present invention, component 122, via AI assisted context abstractor 128, outputs the generated recommendations (e.g., visualizations 152, events 154 and data feeds 156) to one or more users via mobile application 158 on computing device 110. In various embodiments of the present invention, interface 107 enables visual display of visualizations 152, events 154 and data feeds 156 to one or more users.

FIG. 4 depicts a block diagram of components of server computer 120 within distributed data processing environment 100 of FIG. 1, in accordance with an embodiment of the present invention. It should be appreciated that FIG. 4 provides only an illustration of one implementation and does not imply any limitations with regard to the environments in which different embodiments may be implemented. Many modifications to the depicted environment may be made.

FIG. 4 depicts computer system 400, where server computing 120 represents an example of computer system 400 that includes component 122. The computer system includes processors 401, cache 403, memory 402, persistent storage 405, communications unit 407, input/output (I/O) interface(s) 406, display 409, external device(s) 408 and communications fabric 404. Communications fabric 404 provides communications between cache 403, memory 402, persistent storage 405, communications unit 407, and input/output (I/O) interface(s) 406. Communications fabric 404 may be implemented with any architecture designed for passing data and/or control information between processors (such as microprocessors, communications, and network processors, etc.), system memory, peripheral devices, and any other hardware components within a system. For example, communications fabric 404 may be implemented with one or more buses or a crossbar switch.

Memory 402 and persistent storage 405 are computer readable storage media. In this embodiment, memory 402 includes random access memory (RAM). In general, memory 402 may include any suitable volatile or non-volatile computer readable storage media. Cache 403 is a fast memory that enhances the performance of processors 401 by holding recently accessed data, and data near recently accessed data, from memory 402.

Program instructions and data used to practice embodiments of the present invention may be stored in persistent storage 405 and in memory 402 for execution by one or more of the respective processors 401 via cache 403. In an embodiment, persistent storage 405 includes a magnetic hard disk drive. Alternatively, or in addition to a magnetic hard disk drive, persistent storage 405 may include a solid-state hard drive, a semiconductor storage device, read-only memory (ROM), erasable programmable read-only memory (EPROM), flash memory, or any other computer readable storage media that is capable of storing program instructions or digital information.

The media used by persistent storage 405 may also be removable. For example, a removable hard drive may be used for persistent storage 405. Other examples include optical and magnetic disks, thumb drives, and smart cards that are inserted into a drive for transfer onto another computer readable storage medium that is also part of persistent storage 405.

Communications unit 407, in these examples, provides for communications with other data processing systems or devices. In these examples, communications unit 407 includes one or more network interface cards. Communications unit 407 may provide communications through the use of either or both physical and wireless communications links. Program instructions and data used to practice embodiments of the present invention may be downloaded to persistent storage 405 through communications unit 407.

I/O interface(s) 406 enables for input and output of data with other devices that may be connected to each computer system. For example, I/O interface 406 may provide a connection to external devices 408 such as a keyboard, keypad, a touch screen, and/or some other suitable input device. External devices 408 may also include portable computer readable storage media such as, for example, thumb drives, portable optical or magnetic disks, and memory cards. Software and data used to practice embodiments of the present invention may be stored on such portable computer readable storage media and may be loaded onto persistent storage 405 via I/O interface(s) 406. I/O interface(s) 406 also connect to display 409.

Display 409 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium may be any tangible device that may retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein may be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, may be implemented by computer readable program instructions.

These computer readable program instructions may be provided to a processor of a general-purpose computer, a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that may direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures (i.e., FIG.) illustrate the architecture, functionality, and operation of possible implementations of systems, methods, and computer program products according to various embodiments of the present invention. In this regard, each block in the flowchart or block diagrams may represent a module, a segment, or a portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, may be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method for providing recommendations based on extracted context from a plurality of IoT devices, the computer-implemented method comprising:
abstracting specific messaging formats from various IoT devices;
mapping, by a canonical data mapper, the abstracted messaging formats to a canonical model associated to device types using based on collected IoT device data;
determining a context of data received from the plurality of IoT devices based on the type of IoT device and historical trend analysis of canonical data points from similar device types;
deriving an association between data points among the plurality of IoT devices in a solution;
determining one or more contexts of the established data point associations in the solution;
recommending one or more charts, events, and associated data based on a derived context and a visualization map; and
outputting, by a user interface, the recommended chart events and associated data.

2. The computer-implemented method of claim 1, further comprising:
collecting, by the canonical data mapper, the IoT device data from a plurality of IoT device; and
retrieving, by the canonical data mapper, one or more existing canonical data models from a database.

3. The computer-implemented method of claim 1, further comprising:
generating one or more new canonical data models based on the received IoT data; and
outputting the one or more new canonical data models.

4. The computer-implemented method of claim 1, further comprising:
generating, by the canonical data mapper, a generalized data set based on collected data and existing canonical data model by matching IoT data with one or more retrieved canonical models.

5. The computer-implemented method of claim 1, further comprising:
identifying datapoints between the received and/or retrieved IoT device data and datapoints in one or more historical IoT data profiles;
profiling one or more IoT data feeds from the plurality of IoT devices; and
creating an association between datapoints in the IoT device data and the datapoints in one or more historical IoT data profiles.

6. The computer-implemented method of claim 1, further comprising:
deriving context from generated data and identified data association; and
mapping, by a contextual mapping engine, the generated context and generated visual representations.

7. The computer-implemented method of claim 1, wherein generating the recommendations comprises:
executing an artificial intelligence (AI) assisted context abstractor to consume data context and one or more visualization mappings based on the data in a current form and the data context.

8. A computer system for providing recommendations based on extracted context from a plurality of IoT devices, the computer system comprising:
one or more computer processors;
one or more computer readable storage devices;
program instructions stored on the one or more computer readable storage devices for execution by at least one of the one or more computer processors, the stored program instructions comprising:
program instructions to abstract specific messaging formats from various IoT devices;
program instructions to map, by a canonical data mapper, the abstracted messaging formats to a canonical model associated to device types using based on collected IoT device data;
program instructions to determine a context of data received from the plurality of IoT devices based on the type of IoT device and historical trend analysis of canonical data points from similar device types;
program instructions to derive an association between data points among the plurality of IoT devices in a solution;
program instructions to determine one or more contexts of the established data point associations in the solution;
program instructions to recommend one or more charts, events, and associated data based on a derived context and a visualization map; and
program instructions to output, by a user interface, the recommended chart events and associated data.

9. The computer system of claim 8, further comprising:
program instructions to collect, by the canonical data mapper, the IoT device data from a plurality of IoT device; and
program instructions to retrieve, by the canonical data mapper, one or more existing canonical data models from a database.

10. The computer system of claim 8, further comprising:
program instructions to generate one or more new canonical data models based on the received IoT data; and
program instructions to output the one or more new canonical data models.

11. The computer system of claim 8, further comprising:
program instructions to generate, by the canonical data mapper, a generalized data set based on collected data and existing canonical data model by matching IoT data with one or more retrieved canonical models.

12. The computer system of claim 8, further comprising:
program instructions to identify datapoints between the received and/or retrieved IoT device data and datapoints in one or more historical IoT data profiles;
program instructions to profile one or more IoT data feeds from the plurality of IoT devices; and
program instructions to create an association between datapoints in the IoT device data and datapoints in one or more historical IoT data profiles.

13. The computer system of claim 8, further comprising:
program instructions to derive context from generated data and identified data association; and
program instructions to map, by a contextual mapping engine, the generated context and generated visual representations.

14. The computer system of claim 8, wherein generating the recommendations comprises:
program instructions to execute an artificial intelligence (AI) assisted context abstractor to consume data context and visualization mappings based on the data in a current form and the data context.

15. A computer program product for providing recommendations based on extracted context from a plurality of IoT devices, the computer program product comprising:
one or more computer readable storage devices and program instructions stored on the one or more computer readable storage devices, the stored program instructions comprising:
program instructions to abstract specific messaging formats from various IoT devices;
program instructions to map, by a canonical data mapper, the abstracted messaging formats to a canonical model associated to device types using based on collected IoT device data;
program instructions to determine a context of data received from the plurality of IoT devices based on the type of IoT device and historical trend analysis of canonical data points from similar device types;
program instructions to derive an association between data points among the plurality of IoT devices in a solution;
program instructions to determine one or more contexts of the established data point associations in the solution;
program instructions to recommend one or more charts, events, and associated data based on a derived context and a visualization map; and
program instructions to output, by a user interface, the recommended chart events and associated data.

16. The computer program product of claim 15, further comprising:
program instructions to collect, by the canonical data mapper, the IoT device data from a plurality of IoT device; and
program instructions to retrieve, by the canonical data mapper, one or more existing canonical data models from a database.

17. The computer program product of claim 15, further comprising:
program instructions to generate one or more new canonical data models based on the received IoT data;
program instructions to output the one or more new canonical data models; and
program instructions to generate, by the canonical data mapper, a generalized data set based on collected data and existing canonical data model by matching IoT data with one or more retrieved canonical models.

18. The computer program product of claim 15, further comprising:
program instructions to identify datapoints between the received and/or retrieved IoT device data and datapoints in one or more historical IoT data profiles;
program instructions to profile one or more IoT data feeds from the plurality of IoT devices; and
program instructions to create an association between datapoints in the IoT device data and datapoints in one or more historical IoT data profiles.

19. The computer program product of claim 15, further comprising:
program instructions to derive context from generated data and identified data association; and
program instructions to map, by a contextual mapping engine, the generated context and generated visual representations.

20. The computer program product of claim 15, wherein generating the recommendations comprises:
program instructions to execute an artificial intelligence (AI) assisted context abstractor to consume data context and visualization mappings based on the data in a current form and the data context.
